(19) United States
(12) Patent Application Publication
(10) Pub. No.: US 2010/0009703 A1
(43) Pub. Date: Jan. 14, 2010

(54) SYSTEM AND METHOD FOR REAL WORLD INTERFACE TO ONLINE SOCIAL NETWORKS

(75) Inventor: Julien Sornay, Paris (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wuiper, Inc., Palo Alto, CA (US)

(21) Appl. No.: 12/502,135

(22) Filed: Jul. 13, 2009

Related U.S. Application Data
(60) Provisional application No. 61/080,631, filed on Jul. 14, 2008.

(51) Int. Cl. H04W 4/12

(52) U.S. Cl. 455/466

(57) ABSTRACT

A system for providing communications between a first person and a second person includes one or more tokens. Each of the one or more tokens includes a unique identifier. The system also includes a server configured to receive the unique identifier and a first message associated with the unique identifier from the first person. The server is also configured to receive the unique identifier from the second person and transmit the first message to the second person in response to receiving the unique identifier from the second person. The server is further configured to receive a second message associated with the unique identifier from the second person and transmit the second message to the first person.

### CROSS-REFERENCES TO RELATED APPLICATIONS

The present application claims benefit under 35 U.S.C. §119(e) of U.S. Provisional Patent Application No. 61/080,631, filed on Jul. 14, 2008, entitled “System and Method for Real World Interface to Online Social Networks,” the disclosure of which is hereby incorporated by reference in its entirety for all purposes.

### BACKGROUND OF THE INVENTION

This present invention relates generally to social networks. More particularly, the invention relates to a method and system for providing an interface between personal interactions and internet-based or online social networks. These personal interactions can include communication through mobile devices. Merely by way of example, the invention has been applied to a new communication tool that will allow people to form more meaningful relationships by simplifying the initial meeting process. The scope of the methods and systems described herein is also applicable to interfaces characterized by a broader scope.

Marketing studies have demonstrated that teens are the most avid online user, with 22 million internet users among teens. On average one in two American teens log onto the internet every day. Additionally, teens are the most active daters, with 68% of girls between 13 and 18 admitting that boys are one of their main topics of conversation. 53% of boys between 13 and 18 admit that girls are one of their main interests, just after sports and music.

However, despite their significant online use and interest in the opposite sex, many teens are unable to find friends and dates. Thus, there is a need in the art for a new communication tool that will allow teens to form more meaningful relationships by simplifying the initial meeting process.

### SUMMARY OF THE INVENTION

According to an embodiment of the present invention, a secure and fun physical world to digital world transition is provided that allows even the most furtive encounters in the physical world to be explored and expanded further into the digital world. This system is referred to herein as Wuiper.

According to another embodiment of the present invention, a method of communication is provided. The communication can be between a first person and a second person. The method includes providing a token (called a Wuip) including an identifier (e.g., including an alphanumeric set of characters or one or more campaign characters and one or more identity characters) and transmitting the identifier to a server. The method also includes transmitting a first message to the server and delivering the token from a first person to a second person. The first message can include text, an image, video content, or audio content. Delivering the token from the first person to the second person can include tossing or placing the token on a personal belonging of the second person. The method further includes transmitting the identifier to the server to retrieve the first message, which can be performed by the second person using a mobile device or a computer.

According to this embodiment, transmitting the identifier to the server can include sending a text message to an SMS server or entering a message using a website (e.g., www.wuiper.com). A second message can be transmitted to the server after retrieving the first message and the second message can include text, an image, video content, or audio content. The first message and the identifier can be transmitted to the server by the first person using a mobile device or a computer.

According to another embodiment of the present invention, a method of communication is provided. The method includes receiving a unique identifier from a first entity and receiving a first message from the first entity. The method also includes receiving the unique identifier from a second entity and transmitting the first message to the second entity. The method optionally includes receiving a second message from the second entity and transmitting the second message to the first entity.

According to an alternative embodiment of the present invention, a system for providing communications between a first person and a second person is provided. The system includes one or more tokens. Each of the one or more tokens includes a unique identifier. The system also includes a server configured to receive the unique identifier and a first message associated with the unique identifier from the first person. The server is also configured to receive the unique identifier from the second person and transmit the first message to the second person in response to receiving the unique identifier from the second person. The server is further configured to receive a second message associated with the unique identifier from the second person and transmit the second message to the first person. Additional messages can also be sent, enabling an entire and potentially endless conversation to be conducted in a totally anonymous manner.

Numerous benefits are achieved using the present invention over conventional techniques. For example, an embodiment according to the present invention provides a way for people to meet each other in a gradual manner. Additionally, embodiments of the present invention provide a person with the ability to break the ice, when meeting another person, instead of having to think on one's feet without any common ground during an initial encounter with the other person. Moreover, embodiments allow for the reduction of bad surprises that dating sites usually afford. For instance, meeting someone in the flesh enables the evaluation of someone on more tangible factors than a profile photo would allow for on such a dating site. Depending upon the embodiment, one or more of these benefits may exist. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 illustrates the use of an embodiment of the present invention as an icebreaker.

FIG. 2A is a simplified illustration of a physical token, which may be referred to as a Wuip, according to an embodiment of the present invention;

FIG. 2B is a simplified diagram of two Wuips in a Wuiplet according to an embodiment of the present invention;

FIG. 2C is a simplified schematic diagram of dimensions for two Wuips on a Wuiplet according to an embodiment of the present invention;

FIG. 2D is a simplified illustration of a Wuiplet in which Wuips can be stored according to an embodiment of the present invention;

FIG. 2E is a simplified drawing of a Wuip according to an alternative embodiment of the present invention;

FIG. 2F is a simplified drawing of packaging of one or more Wuips according to an embodiment of the present invention;

FIG. 3 is a simplified diagram illustrating marketing channels provided by an embodiment of the present invention;

FIG. 4 is simplified diagram illustrating opportunities for brands/sponsors using Wuiper;

FIG. 5 is a simplified flowchart of a method of using Wuiper according to an embodiment of the present invention;

FIG. 6 is a simplified diagram illustrating the operation of an embodiment of the present invention in an SMS implementation;

FIG. 7 is simplified diagram illustrating how the Wuiper system works in various embodiments of the present invention;

FIG. 8 is a simplified flowchart illustrating a method of operating a messaging system according to an embodiment of the present invention; and

FIG. 9 is a simplified screenshot of a web page utilizing in embodiments of the present invention.

### DETAILED DESCRIPTION OF SPECIFIC EMBODIMENTS

On any given day, many people come into personal contact others in social situations or in public places. Some times, such people have had the desire to strike up a conversation with others with which they come into personal contact. In the romantic sphere, these situations are often perceived as missed opportunities that can gnaw at a person for quite some time. A teenager may run into someone they are initially attracted to, without necessarily having the gall or courage to walk up and introduce himself or herself.

On most occasions, when initially meeting someone, there is a barrier or a sense of awkwardness, before regular conversation ensues and a sense of comfort occurs. The two human beings typically need to reach some sense of synchrony within their communication, and even body language. This feeling, often times, is the source for shyness, which in turn, is believed to have cost some people the opportunity to meet new people. We refer to the barrier to meeting someone as the meeting gap. Many businesses have attempted to market goods and services based on the difficulty in establishing the initial personal communication. Online dating sites, matrimonial agencies, and social networks have all tried to bridge the meeting gap. Despite the various attempts to bridge the meeting gap, there is a need in the art for a new communication tool that will allow people to form more meaningful relationships by simplifying the initial meeting process.

According to the present invention, techniques related to social networks are provided. More particularly, the invention relates to a method and system for providing an interface between personal interactions and internet-based or online social networks. Merely by way of example, the invention has been applied to a new communication tool that will allow people to form more meaningful relationships by simplifying the initial meeting process. The scope of the methods and systems described herein is also applicable to interfaces characterized by a broader scope.

The inventor has noted that although many businesses have attempted to bridge the meeting gap, very few, if any, have catered to the teen market. This situation is present, despite the fact that 85% of dating relationships for teens were initiated in an offline meeting. Thus, embodiments of the present invention provide methods and systems that provide for offline meetings between teens and others to progress to a dating relationship.

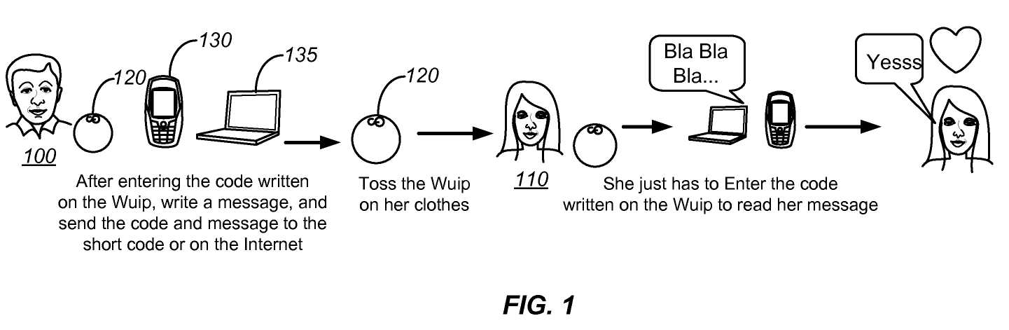

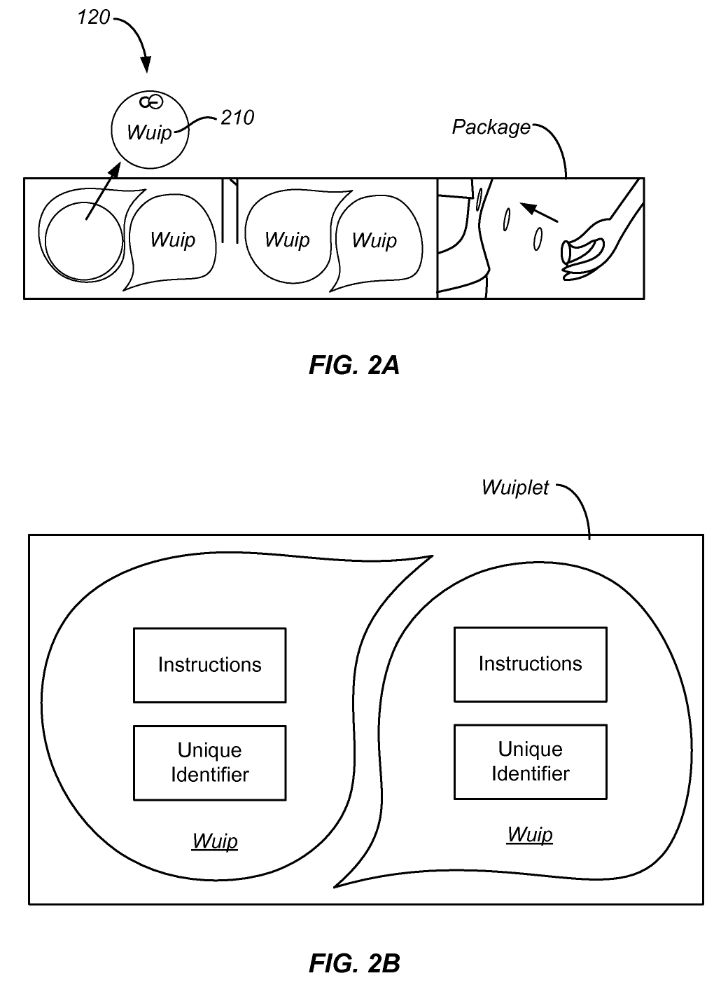

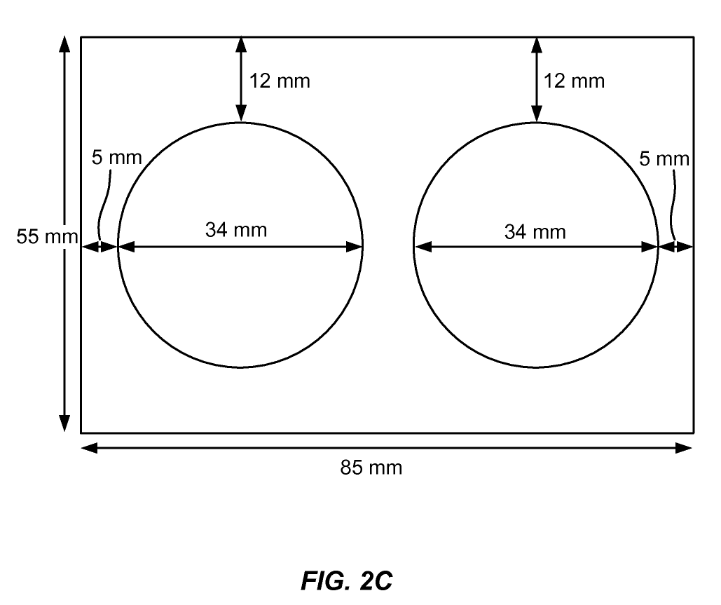

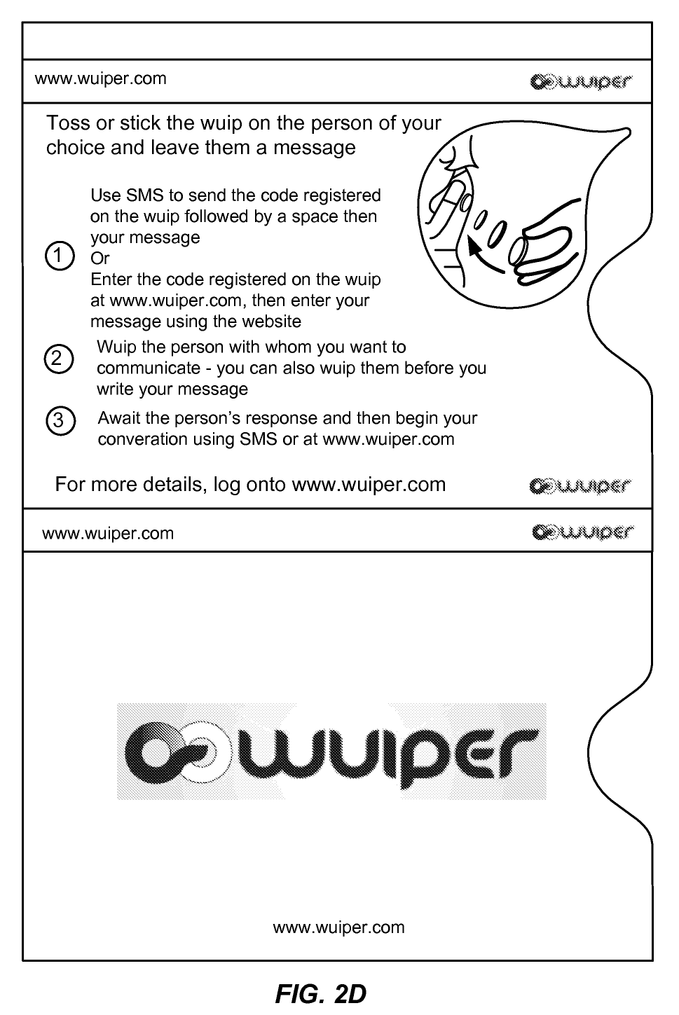

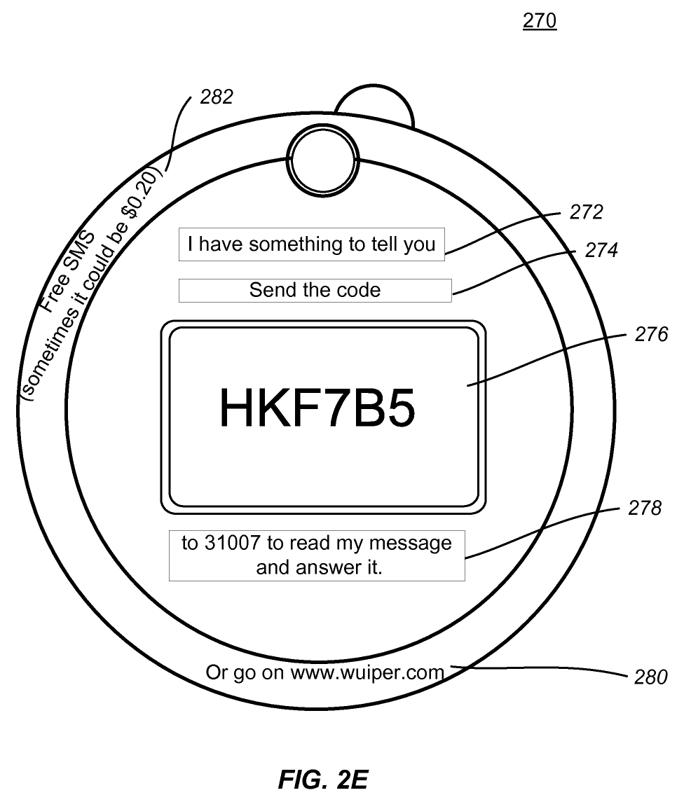

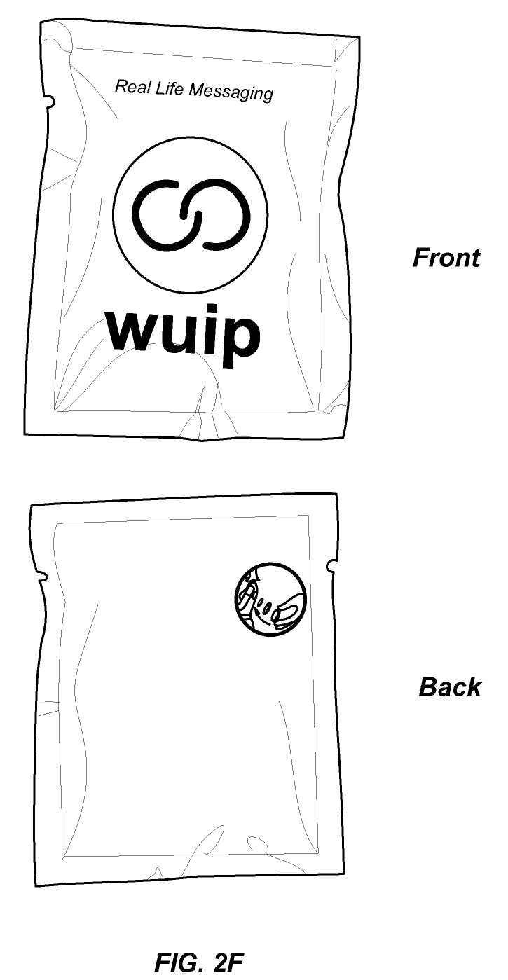

FIG. 1 illustrates the use of an embodiment of the present invention as an icebreaker. Referring to FIG. 1, a method is provided for using a service according to an embodiment, referred to as Wuiper, as an online/offline icebreaker application, facilitating a meeting or initial encounter between a first person 100 and a second person 110. Some environments where a Wuiper could be used to facilitate a meeting or initial encounter between a first person and a second person can include a school setting (e.g. the first day of class at the start of each academic year), bars, clubs, concerts, etc. As illustrated in FIG. 1, person 100 desires to meet person 110. The embodiment of the present invention illustrated in FIG. 1 utilizes a physical token 120. The physical token 120, which may be referred to as an offline designer token, a Wuip, or other suitable identifier, is illustrated in FIG. 2A.

As shown in FIG. 2A, the physical token 120, which may be referred to as a “Wuip,” is a sticky, small flat disc, roughly the size of a small cookie, that is to be tossed underhand onto the targeted person in a particular embodiment. The Wuip 120 sticks to clothing or other personal belongings, without altering the object to which it is attached. Additionally, the physical token 120 includes a unique identifier or code 210. In the embodiment illustrated in FIG. 2A, the unique identifier 210 is a 6-character alphanumeric code that is uniquely provided to the physical token. Although a 6-character alphanumeric code is illustrated in FIG. 2A, this particular implementation is not required by embodiments of the present invention. Other methods of providing a unique identifier are included within the scope of embodiments described herein, including other numbers of characters, different symbols, barcodes, mobile codes, and the like. The physical token 120 also includes one or more symbols or messages such as the name of a company, an advertising message, or the like. One of ordinary skill in the art would recognize many variations, modifications, and alternatives.

FIG. 2B is a simplified diagram of two Wuips in a Wuiplet according to an embodiment of the present invention. The Wuiplet, which provides a larger packaging element that is easily handled, may include text, as illustrated in FIG. 2B, company logos, trademarked items, symbols, images, combinations, thereof, or the like. In addition to the code 210, the Wuips illustrated in FIG. 2B include instructions for use as described more fully throughout the present specification.

FIG. 2C is a simplified schematic diagram of dimensions for two Wuips on a Wuiplet according to an embodiment of the present invention. The dimensions illustrated in FIG. 2C are merely provided as examples and are not intended to limit embodiments of the present invention. FIG. 2D is a simplified illustration of a Wuiplet in which Wuips can be stored according to an embodiment of the present invention. Generally, the Wuiplet is made from cardboard or other suitable material that provides a housing for insertion of one or more Wuips. During use, the Wuips are removed from the Wuiplet and used as described more fully throughout the present specification. Although the Wuiplets illustrated in FIGS. 2A and 2B include text, other embodiments include icons or images, combinations of images and text, or the like. Advertising messages may be included on the outside or inside of the Wuiplet. The Wuiplet may be provided in an envelope or other suitable packaging. The particular form of the Wuiplet illustrated in FIG. 2D is not intended to limit embodiments of the present invention.

FIG. 2E is a simplified drawing of a Wuip 270 according to an alternative embodiment of the present invention. Wuip 270 is a disk shaped object having a front surface and a back surface. The front surface, which is shown in FIG. 2E, includes a first message 272, a first instruction 274, a code 276, an identifier (with instructions) 278, a location 280 such as a website, and an advertisement 282. The first message 272 is intended to be read by the recipient of the Wuip 270 and can be a message such as “I Have something to tell you.” The first instruction 274 can be request to the recipient of the of the Wuip 270 such as “Send the code.” The code 276 can be a sequence of alpha numeric characters that is used to identify specific data to be retrieved from a memory, such as a server. The identifier (with instructions) 278 is an address which the recipient of the Wuip 270 is requested to access. The identifier (with instructions) 278 can be an electronic address with instructions to access it such as “SHORTCODE to 31007 to read my message and answer it” or it can be another address such as the location of a kiosk at a social event. The location 280 can be a website such as www.wuiper.com, which can be accessed by the recipient of the Wuip 270, where the identifier 278 can be inputted to access information. The location 280 can also be the name or number or a room in a social event where the recipient can go to and input the information on the identifier 278. The advertisement 282 can include information such as the cost of the Wuip 270, a sponsor of a social event or any other information that can be customized for advertisement purposes.

The identifier (with instructions) 278 can also be an anonymous address which the recipient of the Wuip 270 is requested to access. By using an anonymous address, the identity of the person who throws the Wuip 270 can remain anonymous until that person decides that the recipient of the Wuip 270 is interested in making the initial encounter. The identifier directs the recipient of the Wuip 270 to a specific address such as a webpage and then code 276 can further provide access to a specific subset of information stored specifically for the recipient of the Wuip 270. For example, the code 276 may provide an image of the person who initiated the initial encounter or simply more information about the person such as age, height, occupation, etc., as is further discussed throughout the application. In some embodiments, the code 276 can be interchangeable so that one user can have multiple codes for multiple messages. For example, some codes can direct the recipient to messages about social functions and other codes can direct the recipient to see educational messages. The advertisement 282 can include information about the Wuip 270 such as “Free SMS (sometimes it could be $0.20)” or information about a product if the Wuip 270 is used as part of a promotional campaign at a social event.

The back surface of the Wuip 270, which is not shown, contains an adhesive for attaching Wuip 270 to a person's clothing or belongings when the Wuip 270 is tossed at the person's clothing or belongings. The adhesive can be a glue or tape that is sufficiently strong to hold the Wuip 270 attached to the person's clothing or belongings but at the same time weak enough to be easily pulled off by a person. The adhesive is also made of materials that do not damage or alter the person's clothing or belongings. For example, the adhesive can be a water based adhesive that easily dissolves when placed in water. Wuip 270 is also constructed so that its mass is distributed in a manner that increases the chances Wuip 270 will land with the adhesive facing the object to which it is intended to stick. In one embodiment, the Wuip 270 is constructed so that it is heavier on the side with the adhesive. With this mass distribution, the center of gravity of the Wuip 270 will be off centered and will cause the Wuip 270 to have a preference of landing on the side with the adhesive. The Wuip 270 can be constructed out of polymer (e.g., a flexible polymer), plastic, cardboard, metals such as silicon, aluminum, or any other material that is light enough to stick on to a person's clothing or belongings (including fabrics, leathers, polyesters, etc.) with an adhesive. In another embodiment an grabbing surface such as Velcro can be used instead of an adhesive. The Wuip 270 can also be made of bio-degradable green materials. Typically, the thickness and materials of the Wuip are selected to provide a flexible disc that is easily handled by the user.

As discussed above with reference to FIG. 1, Wuip 270 can be tossed onto a persons clothing or personal belongings can be used at social events, schools, work functions, etc. to facilitate initial encounters between people. A person receiving the Wuip 270 would read the message “I Have something to tell you. Send the code XXXXXX to 31007 to read my message and answer it. (www.wuiper.com).” FIG. 2F is a simplified drawing of packaging of one or more Wuips according to an embodiment of the present invention. The packaging illustrated in FIG. 2E shows both the front and back of a package in both French and English. Each package is suitable for a different market. The front of the package includes the WUIP name and logo, a brief description of the product such as “Baseline: Real Life Messaging,” and the contents of the package such as “2 Wuips for text messaging.” The back of the package includes instructions for using the Wuip such as: “Take your Wuip and contact anyone;” and “Throw or stick the Wuip onto a person of your choice and chat with them anonymously through text messaging or on the Internet.” The back of the package can include more detailed instructions such as: “1) Send the code followed by a space and your text message to 31007; 2) Discreetly throw or stick the Wuip onto the person you'd like to contact; 3) Wait until the person retrieves your message at 31007 and continue your conversation anonymously.” Those skilled in the art will realize that more detailed instructions can be used as well as less detailed instructions and that these instructions can alternatively be placed within the package.

Referring once again to FIG. 1, once a person 100 obtains a Wuip 120, the person 100 enters the code 210 provided on the Wuip 120 into an electronic device, such as a mobile telephone 130, a portable computer 135, or other electronic devices not shown for purposes of clarity. Such electronic devices may include, but are not limited to desktop computers, PDAs, smart phones, and the like. In addition to entering the code 210, person 100 may enter one or more messages that will be associated with the code and the token. As described more fully below, the one or more messages, which may include one or more types of media including text, audio, video, images, drawings, graphics, combinations thereof, and the like, will be provided to the person 200 in a later stage of the icebreaker application. Entry of the code 210 and the one or more messages can be performed using one of several methods including through a web site (e.g., www.wuiper.com), using the short message service (SMS) communications protocol, a Facebook application, an iPhone application, a Wuipcode player, or the other suitable methods. One of ordinary skill in the art would recognize many variations, modifications, and alternatives.

After entering the code and the one or more messages, person 100 can tag person 110 with the physical token 120. As illustrated in FIG. 1, the Wuip can be tossed onto the clothes or other personal belongings of the person in an anonymous manner. In some embodiments, person 110 is referred to as the “Wuiped” person since the Wuip is attached to their clothes or other personal belongings by person 100. In one embodiment, the Wuip is attached to the person by an adhesive located on one side of the Wuip. The adhesive has sufficient strength to hold the Wuip, which is light, onto the person's clothes or personal belongings. However, the adhesive is also weak enough that the Wuip can be detached from the person's clothes or belongings by pulling on it. Once person 110 receives the Wuip and enters code 210 using another electronic device, the message from person 100 can be read, viewed, or listened to by person 110. Generally, the Wuip will include instructions to enter the code after logging onto www.wuiper.com or other instructions for entering the code in a suitable manner. Because person 110 enters the code to initiate receipt of the one or more messages from person 100, a time period elapses between the opening of the communications channel in most embodiments. Accordingly, through this exclusive, initially anonymous channel, person 100 and person 110 can send email, text or other messages, photos, audio messages, videos, and the like to each other, deciding whether or not to unveil themselves at their leisure. In some applications, the online conversation may continue for a period of time prior to additional personal interaction. Thus, embodiments of the present invention provide for a private and anonymous one-on-one communication channel between two users that have come into contact, even for a brief period of time. Embodiments of the present invention enable two people to communicate with each other online although neither person knows any contact information for the other person. The code on the Wuip provides the link between the two people and is used to open a communications channel between them.

It should be noted that in conventional SMS messaging, the phone number of the recipient is needed to send a message from a sender. Embodiments of the present invention provide a novel manner of initiating contact despite the fact that the sender may not know the phone number (or other communication identifier such as an e-mail address) of the recipient. By sending the unique identifier and a message to a central server (e.g., an SMS platform) and delivering the unique identifier, by way of the Wuip, to the recipient, the recipient is able to retrieve the message from the central server using the unique identifier. Thus, embodiments of the present invention provide for communication between an initiator and a recipient (e.g., by pushing of messages from the server to the recipient) without the initiator knowing the personal communication information of the recipient.

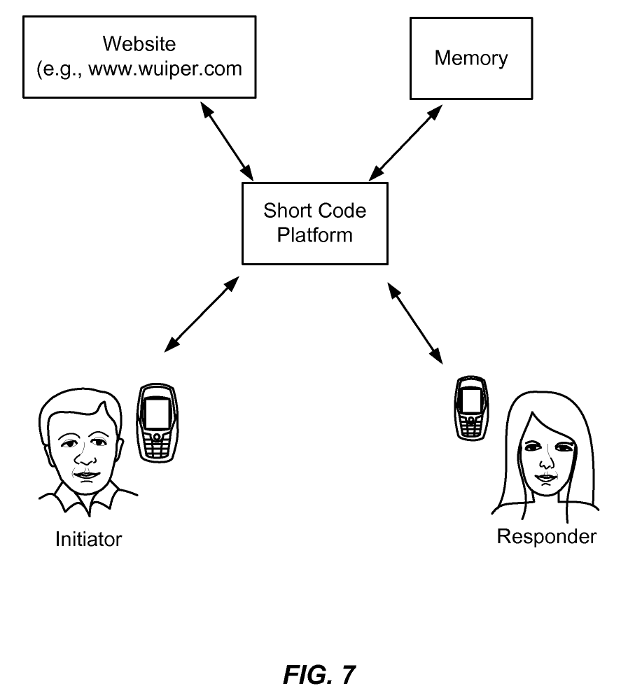

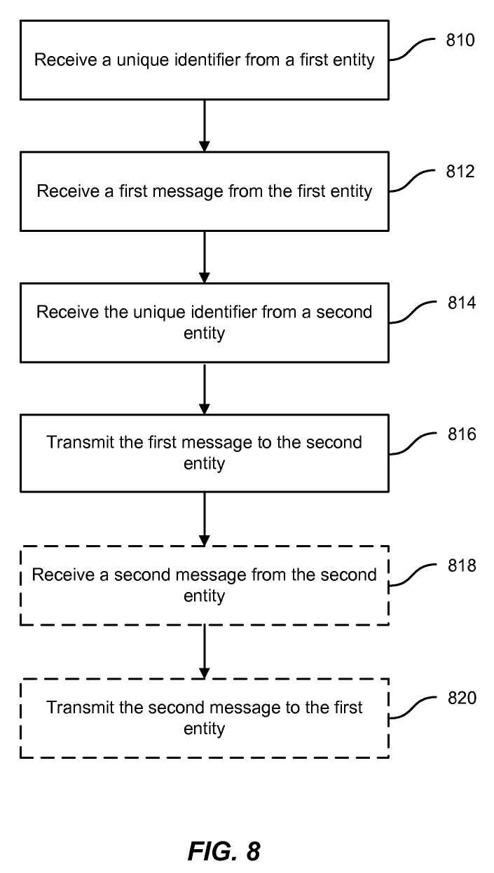

Embodiments of the present invention can be initiated either on the web, through texting, or other suitable communication means. As illustrated in FIG. 7, the Wuiper system operates in multiple environments according to embodiments of the present invention. FIG. 7 illustrates the Wuiper system in the context of an SMS protocol although other protocols are included within the scope of the present invention. A number of system components are coupled to the Short Code Platform, including the website, one or more memories, an initiator (e.g., using an SMS-capable mobile device), and one or more responders (also illustrating using an SMS-capable mobile device). Indirect communication between the initiator and the responder is provided by the system as more fully described throughout the present specification. Embodiments of the present invention provide novel functionality in the context of SMS protocols since communication is possible without knowledge of the phone number of the responder. The website may be used to enter personal information for the initiator and/or responder, including pictures, audio, video, text, drawings, graphics, all digital documents, or the like. The memory may be used to store the SMS history as a single thread accessible through the website, mobile device, laptop, or the like by the initiator and/or responder at a time of their choosing. Communication with the platform can be performed through the website, through other portions of the internet, or from mobile devices as described more fully throughout the present specification. One of ordinary skill in the art would recognize many variations, modifications, and alternatives.

As illustrated in FIG. 7, embodiments of the present invention provide a unique routing system in which one person can connect with another person anonymously using mobile device such as mobile phones as well as through the Internet. The anonymous communication channel is enabled through the use of the unique identifier provided on the Wuip. Embodiments of the present invention provide benefits not achieved by other communication systems, since no login or subscription is required to use Wuiper. In conventional SMS messaging, the phone number of the recipient is needed to send a message from a sender to the recipient. Embodiments of the present invention provide a novel manner of initiating contact despite the fact that the sender may not know the phone number of the recipient. By sending the code written on the Wuip (as a unique identifier) and a message to a central server (the SMS platform)and delivering the unique identifier, by way of the Wuip, to the recipient, the recipient is able to retrieve the message from the central server using the same unique identifier (the code). The phone numbers of the sender and recipient remain anonymous. For both SMS and Internet protocols, a server stores appropriate information and can send this information on to www.wuiper.com and/or to the mobile phones of the users. Embodiments of the present invention provide the possibility of filing the SMS activity of a user on the web accounts of the users for them to carry on a conversation started by SMS. All the personal information filled in by the users (members or not) are updated and stored in the server databases in real time. As will be evident to one of skill in the art, such data is valuable as part of marketing and advertising campaigns on mobile devices or on the Internet.

In an embodiment of the present invention, the cost of the physical token 120 and the operation of the network, including www.wuiper.com, is supported by advertising on the Wuip or the Wuip packaging, the website, and the like. Thus, to users of these advertiser sponsored systems, the systems are free of cost, providing methods to interact with desired people in nearly an unlimited manner. It will be noted that in some communications systems, the service is not completely free, as sending SMS messages for non-sponsored campaigns, will cost the end-user, for example $1/text message as an exemplary US price. Other rates may apply for other world regions. Thus, embodiments of the present invention provide, in addition to a communication tool for the consumer, a viral branding tool for advertisers. Merely by way of example, large consumer brands, which are looking to communicate in a novel way to the teen market (or other target markets) can utilize the Wuip and the Wuiper system described herein as a viral branding medium. Advertising messages in one or more formats can be encapsulated both offline and online, with ad placement on the Wuip itself, and in the form of banner advertising, mobile coupons, and the like. According to some estimates, the market size accessible using embodiments of the present invention is the amount spent on advertising to teens in the United States each year: $20 Billion. As most marketers know, the best time to start a relationship with a consumer is at teen age (out of 10 brands consumed by 25 to 35 year olds, 7 had been adopted during the teen years).

Because of the high desirability of the target markets accessed by embodiments of the present invention, (e.g., High School & College Students, aged 14 to 21), it is highly likely that fashion and consumer brands looking to make an imprint and impression with the target market will likely be willing to pay for visibility on this unique and differentiated mobile advertising medium. A higher form of involvement and interaction with the brand is provided by the methods and systems described herein in comparison with other advertising mediums, which is ideal for engagement marketers. As opposed to other broadcast mediums that offer no real measure of ROI (TV, newspaper, billboards), the Wuip is a highly trackable advertising vehicle through its online side. Every login to www.wuiper.com by a person looking to communication with another person equates to one interaction with the brand. The Wuip provides a naturally viral medium, since for each Wuip used, there are at least 2 people involved in the process.

Embodiments of the present invention provide significant differentiation in comparison to conventional online introduction services. While several dating sites have tried to introduce people in an online setting, with the hope that they would eventually meet offline, these systems have often proved to have severe limitations. Misrepresentation from singles is rampant, and this often creates disappointment when an offline encounter occurs. Utilizing the methods and systems described herein (i.e., the Wuiper system), because the contact point is offline, this potential letdown is, at the very least, prevented uni-directionally. Person 100, who is the “Wuiping” person, has selected his/her target (i.e., the “Wuiped” person 110) because of outward physical characteristics or other information known to person 100, thereby leaving no room for bad surprises on that front. Other means of gradual introduction and interaction used in the past include social networks, but this pre-supposes that the two people that are to meet both belong to the network in question and can both access each other's profiles. Embodiments of the present invention allow for an offline meeting, where natural characteristics come in play: charisma, mannerisms, charm, natural appearance, and response to external stimuli. Wuiper users can then take people for face value in the offline world, and start on more solid grounding, when the online dialogue commences.

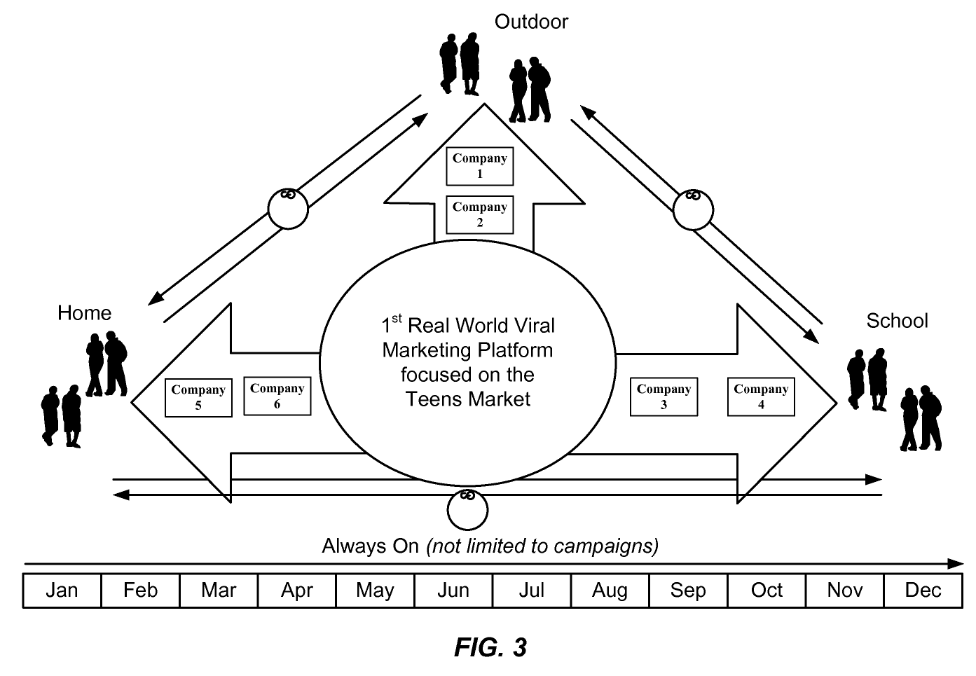

FIG. 3 is a simplified diagram illustrating marketing channels provided by an embodiment of the present invention. As illustrated in FIG. 3, Wuiper leverages existing human connections to facilitate online interactions. Products, brands, and retail establishments can utilize embodiments of the present invention to market their goods and services to consumers (e.g., teens) in a variety of environments including home, school, and outdoors. Since Wuiper provides a viral marketing tool as a type of online word of mouth, messages are communicated in an “Always On” environment that is not limited to campaigns. Studies have shown that teens are hit by 3,000 advertisements a day, partly resulting in the fact that teens are distrustful of marketing claims and are sometimes hostile to conventional advertising. It is believed that teens prefer to make purchasing decisions based on perceived approval by their community. Wuiper creates an offline community that leads to an offline/online game in some embodiments based on dating and gifts. In some embodiments, teens promote products through use of Wuiper, enabling marketers to distribute their message virally.

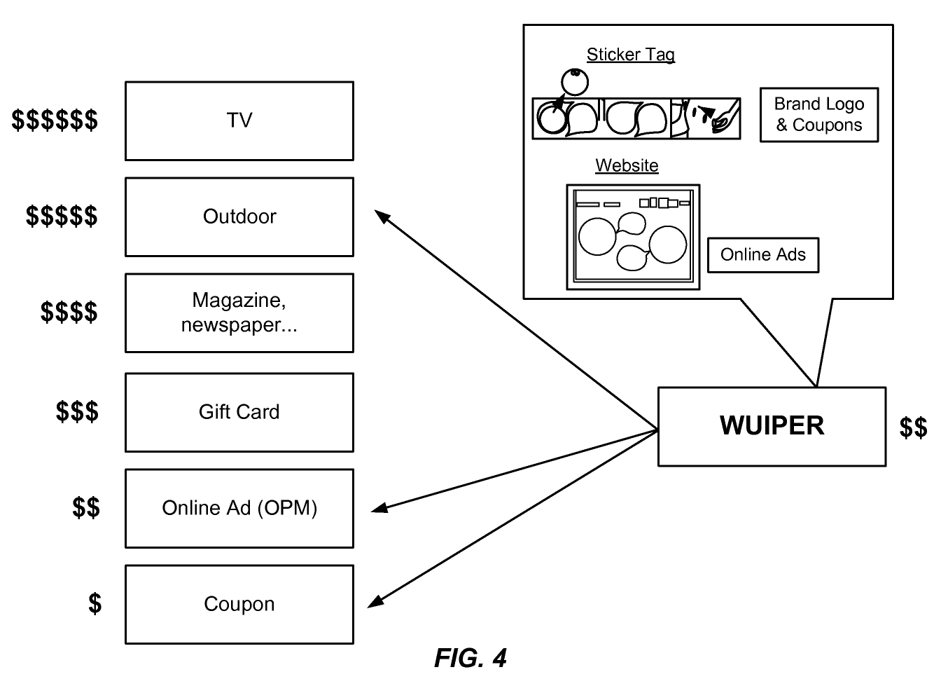

FIG. 4 is simplified diagram illustrating opportunities for brands/sponsors using Wuiper. Wuiper provides a low cost, original, and efficient transversal medium for marketing. In some embodiments, customer acquisition includes original online and offline campaigns for less than three cents. Other embodiments provide similar services at other costs. Appendix A provides additional materials related to operation, marketing, and benefits provided by embodiments of the present invention.

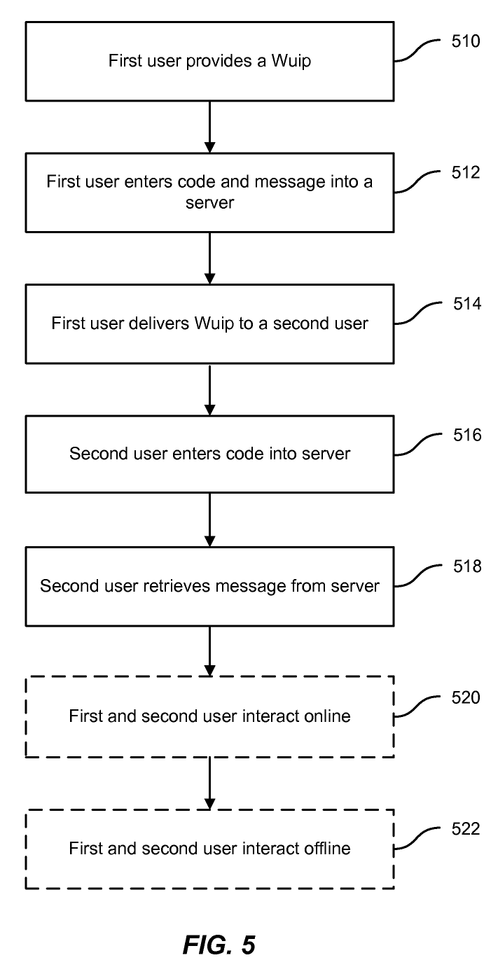

FIG. 5 is a simplified flowchart of a method of using Wuiper according to an embodiment of the present invention. It will be noted that in FIG. 5, operations 512 and 514 can be inverted, as the delivery of the Wuip can happen before the first user has even entered a message through the website or by SMS message. As an example, the method can be utilized when a first person has a message for a second person but doesn't want to email, text, or call them because of lack of personal information (i.e., the first person doesn't have the second person's personal information), shyness on the part of the first person, or because the first person wants to surprise the second person. In operation (510), a first person provides a Wuip, which generally entails removing the Wuip from its packaging. The Wuip includes a unique identifier or code and one or more marketing messages. The packaging of the Wuip additionally includes one or more marketing messages, instructions for use, and the like. In some embodiments, the first person creates an account at www.wuiper.com or utilizes an approved account at another suitable website. In other embodiments, the first person logs into their predefined account at www.wuiper.com or other suitable website. In a specific embodiment, the person sends an SMS message including the code or scans the code (e.g., a mobile code or barcode), thereby initiating transfer of the code to a server using an electronic device (operation 512). Additionally, in operation (512) the first user enters one or more messages into the server. The one or more messages may include various types of media such as text, audio, images, video, drawings, graphics, combinations thereof, and the like. The one or more messages may be created by the first user at the time of entry or be stored on one or more memory devices located in the electronic device or remotely.

In operation (514), the first user delivers the Wuip to a second user, generally by attaching the Wuip to the second person's clothes or other personal belongings. In some embodiments, the first user may place the Wuip in a location (e.g., a desk) accessible by the second user. After the second user receives the Wuip, which may be at a time near the delivery or delayed from the delivery, the second user enters the code into the server in operation (516). In a manner similar to the first user, the second user may enter the code by logging onto a website, scanning the code, imaging the code and uploading the code to the server, and the like. In operation (518), the second user retrieves the one or more messages that the first user has stored on the server. Merely by way of example, the first user can include a picture and an audio tag introducing himself/herself. One of ordinary skill in the art would recognize many variations, modifications, and alternatives.

If the second user is interested in furthering the online interaction with the first user, then in operation (520) the second user can optionally initiate communication through the one-on-one communication channel associated with the unique code on the Wuip. Additional optional offline interaction can also be performed between the users in operation (522). Thus, the Wuiper system provided by embodiments of the present invention provides for anonymous interaction with the pace of personal disclosure determined by the participants.

It should be appreciated that the specific steps illustrated in FIG. 5 provide a particular method of using the Wuiper system according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

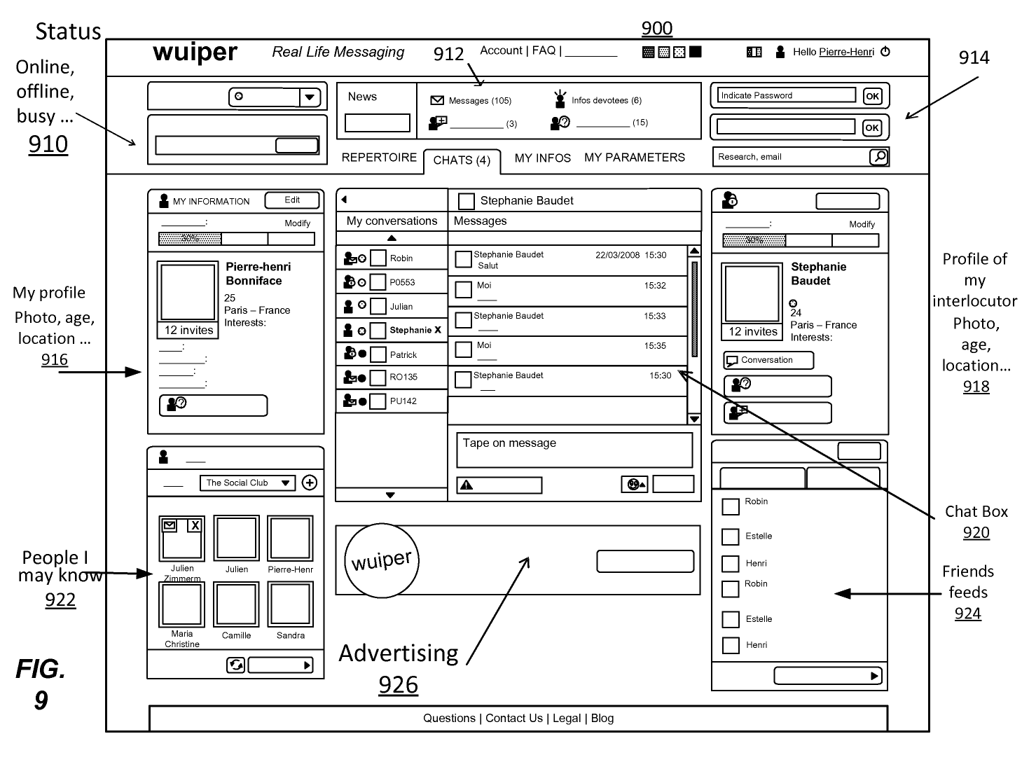

FIG. 8 is a simplified flowchart illustrating a method of operating a messaging system according to an embodiment of the present invention. The method includes receiving a unique identifier from a first entity (810) and receiving a first message from the first entity (812). The first message is associated with the unique identifier. As an example, the unique identifier can be the code on a Wuip. As illustrated in FIG. 2E, the unique identifier may include an alphanumeric set of characters. Additionally, the unique identifier may include one or more campaign characters and one or more identity characters. The campaign characters may be associated with a product or a company related to the campaign. The unique identifier is associated with a token or Wuip as described more fully throughout the present specification.

The method also includes receiving the unique identifier from a second entity (814). In order to receive the unique identifier, the token is passed from a first person to a second person, who can use a mobile device to transmit the unique identifier to a server, for example, an SMS server. Based on receipt of the unique identifier from the second entity, the first message is transmitted to the second entity (816).

In an exemplary implementation, the first person texts the unique identifier and the first message to the SMS server using a mobile device such as a mobile phone, a PDA, or the like. The SMS server either stores the unique identifier and the first message locally or using another computing device. The first message is associated with the unique identifier and can be retrieved and transmitted to the second entity upon receipt of the unique identifier from the second entity. Alternatively, the unique identifier and the first message can be entered using a website, for example, www.wuiper.com. At the website, the first user will enter the unique identifier and the first message, typically after logging into a user account associated with the website. A server associated with the website will store the entered information for later retrieval. Thus, TCP/IP communications can be used to transmit and receive the unique identifier and the first message.

The first message can be text in the form of a text message, one or more images, video content, audio content, or combinations thereof. Using a website, the user can pull images, video, or audio stored via the website and include such media in the first message. Additionally, similar media may be accessible from a mobile device.

As described throughout the present specification, the first entity may be a first communication device operated by a first person and the second entity may be a second communication device operated by a second person. Using this system of communication, the first person can initiate an anonymous communication path with the second person. Without knowing the second person's phone number or email address or other electronic communications identifiers, the first person can post a message on the server, which the second person can retrieve using the unique identifier as a link. Both parties have access to the unique identifier, which is used to provide a link between the users.

In some embodiments, the method includes the optional steps of receiving a second message from the second entity (818) and transmitting the second message to the first entity (820). The second message is associated with the unique identifier. Thus, after the second user receives the first message, the second user can respond to the first user using the communications channel that was created based on the unique identifier. Like the first message, the second message can include text, one or more images, video content, audio content, or combinations thereof. Once this online communication channel has been opened, additional contact information can be exchanged such as names, phone numbers, and other contact information. The communication can transition to off-line communication in which the first and second person meet each other.

It should be appreciated that the specific steps illustrated in FIG. 8 provide a particular method of operating a messaging system according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

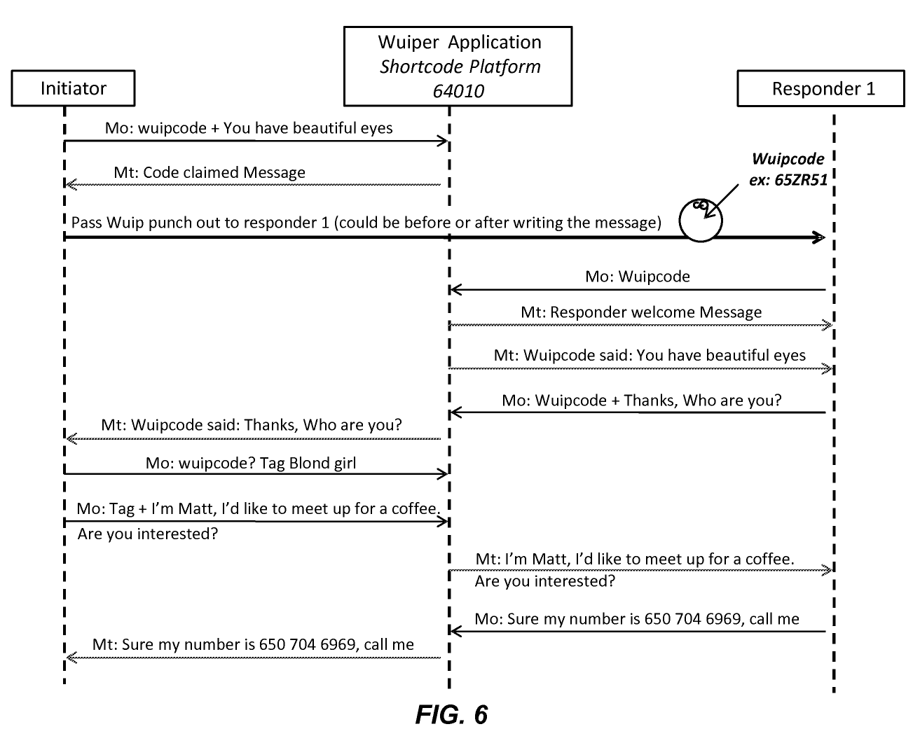

FIG. 6 is a simplified diagram illustrating the operation of an embodiment of the present invention in an SMS implementation. Referring to FIG. 6, an initiator (person with the Wuip), texts the unique identifier and a message (i.e., “You have beautiful eyes,”) using the SMS protocol. Although FIG. 6 illustrates the use of the SMS protocol, embodiments of the present invention are not limited to this particular protocol, but are suitable for use in other environments. For example, the Wuiper website could be used to enter the data illustrated in FIG. 6. One of ordinary skill in the art would recognize many variations, modifications, and alternatives.

The Wuiper Application Shortcode Platform (identified with the exemplary number 64010) responds to the inputs from the initiator with a message (i.e., Code claimed message). The initiator passes the Wuip or a portion thereof (e.g., the punch out portion of the Wuiplet) to the second person, referred to in FIG. 6 as Responder 1. In the present specification, the Wuiplet can be defined as the entire packaging surrounding the punch-out portion, which is referred to as the Wuip itself. The name of the Wuiplet is defined, in part, because of similarities to a leaflet. In a particular embodiment, the Wuip is tossed onto the clothes or other personal belonging of the responder. In other embodiments, the Wuip is a plastic token as illustrated in FIG. 2E. As illustrated in FIG. 6, the order of these steps may be reordered as appropriate to the particular situation. After receiving the Wuip, the responder texts the unique identifier (i.e., the Wuipcode) to the platform and the platform responds with a welcome message. The welcome message may include instructions, advertising, and the like. The platform also sends the message from the initiator (“You have beautiful eyes”) to the responder. In response to the message from the initiator, the responder texts a response message (Thanks, Who are you?), which is received by the platform and forwarded on to the initiator.

The initiator has the ability to tag the Wuipcode with an identifier or tag that can be used to associate the Wuipcode with the responder. In the example illustrated in FIG. 6, the Wuipcode is tagged as “Blonde girl.” Thus, rather than having to remember a series of alphanumeric codes and the people they are associated with, embodiments of the present invention provide for tagging with easily remembered identifiers so that multiple responders can be contacted and remembered. In some embodiments, the tagging is performed at an earlier stage of the process, for example, when the initial message is transmitted. Using either the tag or the Wuipcode, the initiator is able to respond to the message from the responder (“I'm Matt, I'd like to meet up for a coffee. Are you interested?”). After transmission of the response from the platform, additional communication flow between the parties continues as desired.

It should be noted that an alternative to tagging is assignment of identifiers by the platform, enabling a single initiator to contact multiple responders in parallel, communicating with the multiple responders concurrently. For example, if the initiator doesn't choose a tag himself, the server can assign a tag to each of the initiator's conversations automatically (e.g., a sequential number: 1 for person 1, 2 for person 2, and the like).

In some embodiments, the Wuiper system operates in an SMS environment. In these embodiments, the toolkit may be an enterprise application container software, written in Java. The Application (and Wuiper Application) is a software component that provides the functionality described herein as a plug-in for toolkit. In an exemplary embodiment, a campaign may be instituted, which is a particular instance of the application, assigned to a specific short-code, a keyword on that short-code, and a particular set of campaign codes. Campaigns may also differ in language and tone used to send automated messages back to the user, as most of automated messages are entirely configurable.

In an embodiment, the Wuiper is an object the size of a business card, that can be used at parties, clubs, and other social events. In some applications, the Wuiper costs $1 or some other amount and gives the purchaser or user a predetermined amount of chat messages for the purchase price. The Wuiper allows for a connection between an “initiator” and “responder” via an anonymous SMS based chat in an embodiment, through the Wuiper application as a broker in the middle. The Wuiper allows the initiator to claim the Wuiper's unique code printed on the Wuiper, and then use it to leave an anonymous text message for some secretly admired responder. In a particular embodiment, the Wuiper is about the size of a business card, and has a punch out center, approximately the size of a quarter. In a particular implementation, the punch out center is 34 mm in diameter. Both the Wuiper itself and the punch out contain the unique code, and have instructions for the initiator and responder respectively.

In some embodiments, the unique code is a 9-character (e.g., digit) code (e.g., 999-333-444) where the first 3 characters are the campaign's keyword, and the next 6 characters are one of the unique code values loaded into the campaign. Other combinations of characters for the campaign and the unique code may be utilized as well, including a campaign keyword with more than three characters, a two character campaign keyword, one character campaign keyword, or no campaign keyword. The unique code may also be alphanumeric (e.g., the name of a company sponsoring the campaign, products sold by the company, variants on the company name or products, and the like) and contains symbols such as *&%$, or the like. Additionally, the unique code may be other lengths, for example, four characters, five characters, six characters, seven characters, eight characters, ten characters, or more than ten characters. One of ordinary skill in the art would recognize many variations, modifications, and alternatives.

The following hypothetical user scenario is provided by way of example and is not intended to limit the scope of embodiments of the present invention. First the initiator obtains the Wuiper through a promotion at an event. The initiator then follows the instructions and texts the code followed by a secret message. If the code is yet unclaimed, initiator receives the “Code Claimed” message. If they don't supply a secret message in their first MO following the code, an error message is sent to them asking to resend the code with the message appended. If the code is already used (by someone else) or not found, an appropriate error message is generated. Initiator can change their secret message (until it's claimed) by sending the code again, followed by an updated message. The latest message will always be the one that's claimed by the responder. In some applications, the initiator goes through a registration process if not already registered.

An example of registration via text is as follows: After receiving a text message with the Wuipcode and the message, the platform determines that this Wuiper code has not already been used, and is the first time being used, therefore is intended to leave a message (as opposed to picking up the message). The platform also determines the user (initiator or responder) is not already registered. The SMS Platform sends an opt-in SMS message to the user. The user replies YES to the opt-in message. In some applications, if the user does not reply YES within a timeout period, the session is destroyed and the user is not saved. In other applications, the registration of the user on the SMS platform is not utilized. The user is sent an optional BILLING message, this is the PSMS charge. Optionally, if they reply to the welcome message within a timeout period, that will be the Wuiper message that is stored. Otherwise the platform can use the message that came in with the keyword, otherwise use a default per-campaign message. The message is stored in the DM database for later retrieval.

It should be noted that in other embodiments, there is no registration via text/SMS message. Once someone first decides to interact with the SMS platform for the first time (whether or not they are an initiator or a responder) they are automatically registered as a user within the platform. One of ordinary skill in the art would recognize many variations, modifications, and alternatives.

The punch-out is then detached from the Wuiper, and handed out to the responder. The responder (if interested) follows the instructions and texts the code back in. The application then responds back with #1) immediate welcome message, and #2) a slightly delayed (by a configurable 30 seconds) secret message left by the initiator.

If the responder replies directly to the message they received within a configurable timeout, both parties can then engage in an anonymous SMS conversation by replying back to the shortcode (without the unique code). The conversation will remain “open” for a configurable period after the last message sent.

To re-start a new conversation after the time-out, either party will once again text their 9-digit code to the shortcode. If the user replies after their session has timed out, then the default “NACK” message assigned to the shortcode will be sent to the user. If any party decides to quit all chats, they can text the word “stop” and the conversation (and their “membership”) is terminated.

If the party decides to block a particular conversation, they will text the code followed by the configurable command character, and then the word “block”. The actual words used by the commands must be configurable in the campaign UI, to support internationalization (e.g., French or other languages).

Dealing With Multiple Chats

In some embodiments, a single user may use multiple Wuipers at the same event, to target several people. When two people are chatting, this can be viewed mathematically as two concurrent one-way channels of information. In a Wuiper application, each person can only have one active channel where they “speak” (produce messages), but can have multiple concurrent channels directed at them, where they “listen” (consume messages). The channel where the user “speaks” can be referred to as the user's active channel. Each user has one and only one active channel in this illustrated embodiment. A user's passive channel is the channel directed at the user, of which there could be many.

To change their active channel, the user can text another 9-digit code to the application (within the same campaign), and the application will recognize this as a trigger to switch the user's active channel to the new one. Alternatively, the use can text either the tag automatically generated for them (if they haven't yet made one up) or the tag they've already come up with. The user will still continue receiving messages from previously established passive channels (until they stop sending, or the user blocks them).

Code Prefix

The use of multiple concurrent channels provides a benefit if multiple messages from the incoming passive channels can be separately identified. The application can prefix each MT message sent to the user, with a configurable string that would include the full 9-digit code associated with the channel, for example “999-333-444 said: Hey sweetie, what's up?” The actual prefix will be defined by a configuration string that will support macros: % n. The actual prefix will be defined by a configuration string that will support macros: % n for the code, % m for the message and % t for the tag. So to produce a string above, it would be set to: “% n said: % m”.

Tagging

When a user receives messages from other users or replies to their commands, the system prefix consisting of only numbers may become difficult to keep track of. Tagging allows users to add a personal tag to each channel, which will then be used in the prefix (in addition to the code) to provide additional identifiability, e.g., “999-333-444 Tall Chick Sandy said: Hey sweetie, what's up?” In the above example, “Tall Chick Sandy” is the tag the user gave to their Wuiper counterpart. If a user hasn't tagged a particular conversation, a tag will be automatically generated by the SMS platform.

Commands

Embodiments of the present invention provide for a way for users to be in control of their chats, in particular: to switch an active channel to another code to potentially block a user and end conversation to tag a particular code with a descriptive text/name (e.g., ‘red hair jon’) to view the list of active or inactive conversations they're part of. It is suggested that the commands follow the following pattern, where a question mark is what differentiates command from regular conversational text. The command character will generally be a campaign-configurable multi-character string.

Command Description

XXX-XXX-XXX—Switches active conversation, or starts code claiming if unused XXX-XXX-XXX?

list—Shows list of active codes XXX-XXX-XXX?

block—Blocks the conversation attached to the code, and sends the other party configurable block message.

XXX-XXX-XXX? tag Hot Chick—Tags the code with the name “Hot Chick,” which is then used on all messages received from that channel.

Billing

In France, it is possible to bill on each inbound MO and therefore the application does not need to be aware of the billing.

In the U.S., it is determined which MOs are tagged as PAID message in the toolkit. This determination allows the use of an existing toolkit's billing mechanism. The welcome message AKA “code claimed” message is sent out whenever a valid code is claimed by the initiator. This message is not PAID. Subsequently, all messages containing actual content written by a responder or initiator of any conversation, including the secret message, is PAID. Thus by default both initiator and responder get charged, but only when they 1) claim the code and 2) sends a real message out to a real party.

An additional Boolean flag in the campaign configuration should determine whether MTs sent to responder are PAID or not. This allows having a campaign with only the initiator being the PAID party.

Sample Instructions

For an initiator, instructions may look like: “Text your code XXX-XXX-XXX, followed by a secret message, to 81595 to leave your message for someone you admire to claim. Make sure they get the punch out, and they can get your message and then chat with you, all anonymously.”

For a responder, instructions may look like: “Someone has a crush on you, text this code XXX-XXX-XXX to 81595 to find out more and get a message from them.”

FIG. 9 is a simplified screenshot of a web page utilizing in embodiments of the present invention. The Website 900 includes a status widow 910, a news window 912, a code player window 914, a my profile window 916, an interlocutor profile window 918, a chat box 920, people I know window 922, friends feeds window 924, and advertisement window 926. The status window 910 includes information such as whether the user is online, offline busy etc. The news window 912 includes information such as new messages, invitations, friend requests etc. The code player window 914 includes access to the system for performing functions such as read and write Wuip. The my profile window 916 includes information about the user such as photos, images, age, location, occupation, hobbies, etc. The interlocutor profile window 918 includes information about the interlocutor such as photos, images, age, location, occupation, hobbies, etc. The chat box 920 provides a window for communication between several parties. The People I know window 922 includes information about people that the user knows and provides a network of friends and acquaintances. The friends feeds window 924 provides information about the friends feeds. The advertisement window 926 provides a window for advertising that can be used to generate revenue.

As illustrated in FIG. 9, the ChatBox provides for Instant Messenger functionality. People can chat with online users or leave a message for the offline ones. Moreover, the internet chat works with the SMS Chat. As a result, users can read the SMS text messages directly on the website. Additionally, a Notebook feature is provided so that user's contacts and friends are gathered in an easily accessible space. The modularity of this widget enables a personalized notebook archiving system (e.g., lists, thumbnails, and the like. Moreover, a user profile section is provided to enable a user to fill in a complete profile with photos, links, interest, personal information, and the like. Since embodiments of the present invention enable users to communicate anonymously, the user can choose on a case-by-case basis the information they want to communicate using a system of Drag and Drop. Thus, the user can remain totally anonymous to start a chat and increase the amount of personal information available to his correspondent progressively. The user can also disclose 100% of their profile to someone and only 10% to someone else.

Referring to FIG. 9, the Code Player is used to enable users to write or read an anonymous message on the website by entering the code written on the Wuip in this region of the website. Feeds are also provided to offer the possibility to write feeds and to follow friends feeds in real time. Close people is a feature that is both fun and useful. It enables users to discover and get in touch with people who share the same places as them (e.g., Who goes to the same fitness center as me? Who will be in this club next Saturday?). This geographical positioning enables users to tag places on a map associated with their geographical location.

The following examples illustrate several discussion possibilities that can occur with the use of a Wuip.

The first example includes two scenarios (A and B). In scenario A, the initiator first saves a message accessible with an identifier and code and provides a recipient or responder with a Wuip containing the identifier and code to access the pre-saved message. In scenario B the initiator first provides the recipient or responder with the Wuip containing an identifier and code and then prepares and saves a message accessible to the recipient or responder with the use of the identifier and code. In both of these scenarios the recipient or responder reads the message after it has been accessed with the identifier and code by using either an SMS or website. If an SMS is used to access the message then, after the message has been accessed by the recipient or responder, a discussion can take place via either SMS or website. If a computer or website is used to access the message then, after the message has been accessed by the recipient or responder, a discussion can take place via a website without the use of an SMS. The discussion can continue on the website indefinitely.

The second example covers a situation where a mobile number is not filled in a website and also includes two scenarios (C and D). In scenario C, the initiator first saves in a memory, which is located on a computer or website, a message accessible with an identifier and code and provides a recipient or responder with a Wuip containing the identifier and code to access the pre-saved message. In scenario D the initiator first provides the recipient or responder with the Wuip containing the identifier and code and then prepares and saves in a memory, which is located in a compute or website, a message accessible to the recipient or responder with the use of the identifier and code. In both of these scenarios the recipient or responder reads the message after it has been accessed with the identifier and code by using either an SMS or website. If an SMS is used to access the message then, after the message has been accessed by the recipient or responder, a discussion can take place via an SMS. An SMS invitation can be used for passing on the discussion to the website. If a computer or website is used to access the message then, after the message has been accessed by the recipient or responder, a discussion can take place via a website without the use of an SMS. The discussion can continue on the website indefinitely.

The third example covers a situation where a mobile number is filled in a website and also includes two scenarios (E and F). In scenario E, the initiator first saves in a memory, which is located on a computer or website, a message accessible with an identifier and code and provides a recipient or responder with a Wuip containing the identifier and code to access the pre-saved message. In scenario F the initiator first provides the recipient or responder with the Wuip containing the identifier and code and then prepares and saves in a memory, which is located in a compute or website, a message accessible to the recipient or responder with the use of the identifier and code. In both of these scenarios the recipient or responder reads the message after it has been accessed with the identifier and code by using either an SMS or website. If an SMS is used to access the message then, after the message has been accessed by the recipient or responder, a discussion can take place via an SMS or a website. If a computer or website is used to access the message then, after the message has been accessed by the recipient or responder, a discussion can take place via a website without the use of an SMS. The discussion can continue on the website indefinitely.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of communication comprising:
receiving a unique identifier from a first entity;
receiving a first message from the first entity;
receiving the unique identifier from a second entity; and
transmitting the first message to the second entity.

2. The method of claim 1 wherein the first entity is a first communication device operable by first person and the second entity is a second communication device operable by a second person

3. The method of claim 1 wherein the unique identifier comprises an alphanumeric set of characters.

4. The method of claim 1 wherein receiving the unique identifier comprises receiving an SMS text message.

5. The method of claim 4 wherein the SMS text message is transmitted from a mobile device.

6. The method of claim 1 wherein receiving the unique identifier comprises receiving a TCP/IP communication.

7. The method of claim 1 wherein the first message includes text.

8. The method of claim 1 wherein the first message includes at least one of an image, video content, or audio content.

9. The method of claim 1 further comprising:
receiving a second message from the second entity; and
transmitting the second message to the first entity.

10. The method of claim 9 wherein the second message includes at least one of text, an image, video content, or audio content.

11. A system for providing communications between a first person and a second person, the system comprising:
one or more tokens, each of the one or more tokens including a unique identifier; and
a server configured to:
receive the unique identifier and a first message associated with the unique identifier from the first person;
receive the unique identifier from the second person;
transmit the first message to the second person in response to receiving the unique identifier from the second person;
receive a second message associated with the unique identifier from the second person; and
transmit the second message to the first person.

12. The system of claim 11 wherein the unique identifier comprises a set of numbers, letters, or symbols.

13. The system of claim 11 wherein the unique identifier comprises one or more campaign characters and one or more identity characters.

14. The system of claim 11 wherein server comprises an SMS server.

15. The system of claim 11 further comprising one or more memories coupled to the server.

16. The system of claim 11 further comprising a website coupled to the server.

17. A system comprising:
a body;
an identifier disposed on a first side of the body;
an adhesive disposed on a second side of the body;
wherein the system, when tossed at an object, attaches to the object with the adhesive without damaging the object.

18. The system of claim 17 wherein the identifier provides an anonymous address to a memory containing information.

19. The system of claim 18 further comprising a code that specifies a subset of the information.

20. The system of claim 17 wherein the system has a mass distribution that causes the second side of the body with the adhesive to land on the object when the system is tossed at the object.

21. The system of claim 17 wherein the body is a flexible polymer.

22. The system of claim 17 further comprising an advertisement disposed on the first side of the body.

23. The system of claim 17 wherein the adhesive attaches the system to a fabric surface.
